(19) United States
(12) Patent Application Publication
(10) Pub. No.: US 2007/0014548 A1
(43) Pub. Date: Jan. 18, 2007

(54) Recording and playback system and methods regarding the same

(75) Inventors: Rush, Chongqing (CN); Ji Yun Huang, Chongqing (CN)

Correspondence Address: ARENT FOX PLLC, 1050 CONNECTICUT AVENUE, N.W., SUITE 400, WASHINGTON, DC, 20036, US

(73) Assignee: FARSTONE TECH., INC.

(21) Appl. No.: 11/418,468

(22) Filed: May 5, 2006

(30) Foreign Application Priority Data
May 5, 2005 (TW) 94114469

(51) Int. Cl. H04N 5/00

(52) U.S. Cl. 386/126

(57) ABSTRACT

A recording and playback system and methodology that plays video/audio content in appliances. According to the invention, backup/recovery system comprises a CD/DVD emulator, a converter and a display. The CD/DVD emulator is used for creating the video/audio content into an image. The converter is used for converting the image to other formats. The display is used for displaying the converted image. The invention copies a CD or unprotected DVD as a compressed image, which the user can play in place of original discs.

### CROSS-REFERENCE TO RELATED APPLICATIONS

The present application claims priority under 35 U.S.C. §119 to Taiwanese Patent Application No. 94114469, filed May 5, 2005, the contents thereof incorporated by reference herein in its entirety.

### BACKGROUND OF THE INVENTION

1. Field of the Invention

The present invention relates generally to a video recording technique for playback appliances, and more particularly to a broadcast television system and method that copies and plays a CD/DVD.

2. Description of Prior Art

Microsoft® Windows® XP has developed a Media Center Edition and the Media Center PC. The user can watch and record TV, burn DVDs of TV shows, listen to music, play CDs and watch DVD movies. It is also possible to record shows for later playback.

Recorded shows in the Media Center PC are stored with the *.dvr-ms file extension. The DVR-MS file enhancements allow the creation of key PVR functionality, including time-shifting, live pause, and simultaneous record and playback.

When Microsoft Windows XP Media Center Edition records a television show, the result is a DVR-MS file. Before creating the file, the audio and video elementary streams are encrypted. The Stream Buffer Engine (SBE) then writes the file to a directory as a DVR-MS file.

The Media Center user interface allows playback of any recorded TV show. To enable playback of DVR-MS files outside of the Media Center user interface using a DirectShow capable player, the QFE Q329979 must be present and can be installed from Windows Update.

Extended access to DVR-MS files is not limited to playback; editing and authoring applications can also access the files. In some cases, video and audio streams may need to be handled separately during the editing or authoring process.

The video contained in a DVR-MS file is encoded as MPEG-2 video stream. The content consists of MPEG-2 video stream and MPEG-1 Layer 2 audio stream. Synchronization between audio and video requires that the relationship between media sample timestamps be maintained. These timestamps are rebased PES timestamps from 90 kHz to 10 MHz as found in the original PES header's PTS field.

However, a major disadvantage is the large file sizes of DVR-MS files. A two-hour TV show recorded in DVR-MS at the Best quality setting can take up to 5.5 GB on the hard disk, which is reason to convert the unprotected DVR-MS files to some other format like WMV for easy distribution and storage.

Besides, DVR-MS files cannot be easily edited either. So, it is necessary to convert the DVR-MS files to another format, such as AVI. Conversion of DVR-MS files usually takes a long time, since they are high resolution and are highly compressed.

### SUMMARY OF THE INVENTION

The present invention provides a recording and playback system and method to resolve the foregoing problems faced by the conventional technique. The present invention also has the advantage of providing a long time period to the original discs.

An object of the present invention is to provide a recording and playback system and method, wherein wear and tear on the CD/DVD ROM drive can be saved.

Another object of the present invention is to provide a recording and playback system and method, which can create custom virtual CDs and play additional CD/DVDs formats, including data CDs, audio CDs, and MP3s.

In accordance with an aspect of the present invention, a recording and playback system is suitable for appliances for playing video/audio content. The recording and playback system comprises a CD/DVD emulator, a converter and a display. The CD/DVD emulator is used for creating the video/audio content into an image. The converter is used for converting the image to other formats. The display is used for displaying the converted image.

In the preferred embodiment of the invention, the recording and playback system further comprises a CD/DVD burner for burning a disc. The image is a VCD (Video Compact Disc) image. The image is a DVD-Video image.

### BRIEF DESCRIPTION OF THE DRAWINGS

The present invention may best be understood through the following description with reference to the accompanying drawings, in which:

FIG. 1 shows a broadcast schematic block diagram of a recording and playback system of a preferred embodiment according to the present invention.

FIG. 2 shows a record schematic block diagram of a recording and playback system of a preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new technique for appliances to play video/audio contents. The CD or DVD will not be scratched or lost anymore. The users do not need to swap out discs and waiting for them to load. Moreover, the users do not have to lug all those CDs and DVDs around.

According to the preferred embodiment of the present invention, a recording and playback system is suitable for appliances for playing video/audio content. The recording and playback system comprises a CD/DVD emulator, a converter and a display. The CD/DVD emulator is used for creating the video/audio content into an image. The converter is used for converting the image to other formats. The display is used for displaying the converted image.

The recording and playback system further comprises a CD/DVD burner for burning a disc. The image is a VCD (Video Compact Disc) image. The image is a DVD-Video image.

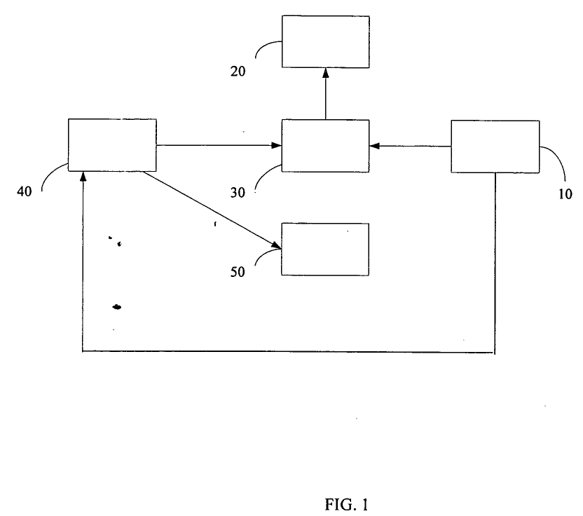

Referring to FIG. 1, a broadcast schematic block diagram of a recording and playback system of a preferred embodiment according to the present invention is shown. The recording and playback system of the present invention includes at least a CD/DVD ROM drive 10, a display 20, an AD/DA converter 30, a CD/DVD emulator 40 and a CD/DVD burner 50.

The user may insert a CD/DVD into the CD/DVD ROM drive 10 on a computer. The CD/DVD emulator 40 is used for creating the video/audio content in the CD/DVD into an image. The CD/DVD burner 50 is used for burning a disc.

The AD/DA converter 30 converts the image to other formats, so as to display the converted content on the display 20. The display 20 may be a TV. The AD/DA converter 30 may convert CD-ROMs, audio CDs, mixed-mode CDs, photo CDs, video CDs (DVD-ROMs data-mode), and unencrypted video DVDs.

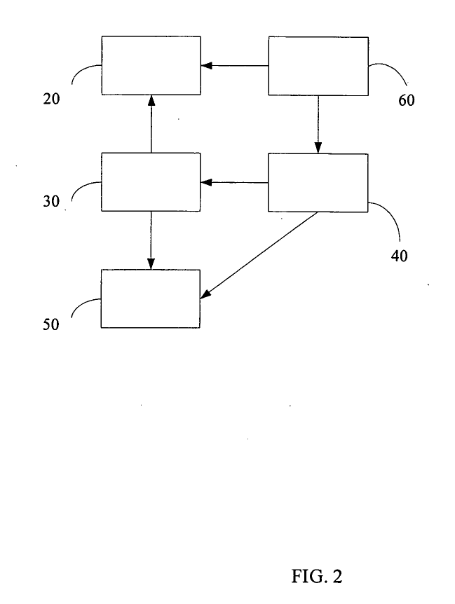

Referring to FIG. 2, a record schematic block diagram of a recording and playback system of a preferred embodiment according to the present invention is shown. According to the present invention, the user can record shows. The recording and playback system is capable of recording TV content on the PC.

The receiver 60 receives Video/Audio message from outside. The message is sent to the display 20. The display 20 may be a TV. The CD/DVD emulator 40 is used for creating the video/audio content from outside into an image. The CD/DVD burner 50 is used for burning a disc.

The AD/DA converter 30 converts the image to other formats, so as to record TV content on the PC. The show can be played back. The AD/DA converter 30 may convert CD-ROMs, audio CDs, mixed-mode CDs, photo CDs, video CDs (DVD-ROMs data-mode), and unencrypted video DVDs.

The present invention emulates a CD or DVD as a virtual CD/DVD, which the user can play in place of original discs in any one of virtual CD/DVD ROM drives that the recording and playback system creates. Virtual CD/DVD can be shared over a network or transported on a computer or USB device.

The recording and playback system according to the present invention can run the virtual CD/DVD directly on the appliances, saving wear and tear on your CD-ROM drive. Furthermore, by using the recording and playback system of the present invention, the virtual CD/DVD can be created while playing or recording the original CD/DVD discs.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A recording and playback system, suitable for appliances for playing video/audio content, said recording and playback system comprising:
a CD/DVD emulator for creating said video/audio content into an image;
a converter for converting said image to other formats; and
a display for displaying said converted image.

2. The recording and playback system according to claim 1, wherein said image is a VCD (Video Compact Disc) image.

3. The recording and playback system according to claim 1, wherein said image is a DVD-Video image.

4. The recording and playback system according to claim 1, further comprising a CD/DVD burner for burning a disc.
